(19) United States
(12) Patent Application Publication
(10) Pub. No.: US 2018/0057071 A1
(43) Pub. Date: Mar. 1, 2018

(54) GRILLE SELF-CENTERING GUIDANCE TABS

(71) Applicant: FORD GLOBAL TECHNOLOGIES, LLC, Dearborn, MI (US)

(72) Inventors: Jeffery Lee, Tecumseh (CA); Joseph Andrew Hickey, Rochester, MI (US); Steven Michael Lakatos, Waterford, MI (US); Justin Carroll, New Baltimore, MI (US); Jason Orville Gridley-Waters, Dearborn, MI (US); Shivam Agarwal, Louisville, KY (US)

(21) Appl. No.: 15/251,357

(22) Filed: Aug. 30, 2016

(51) Int. Cl. B62D 27/06; B62D 25/08; B60Q 1/04

(52) U.S. Cl. CPC B62D 27/06; B60Q 1/0441; B62D 25/08

(57) ABSTRACT

A self-locating fastener tab for connecting a first vehicle element to a second vehicle element includes a body comprising a head portion and a flexible neck portion. The flexible neck portion includes a first neck length, a second neck length, and an intervening flexible length having a greater degree of flexibility than either of the first neck length and the second neck length. The intervening flexible length may define a living hinge.

### TECHNICAL FIELD

This disclosure relates generally to motor vehicle grille assemblies. More particularly, the disclosure relates to a guidance tab, configured for enhanced flexibility to provide self-centering and locator functions for proper attachment of a first vehicle element to a second vehicle element such as a motor vehicle grille.

### BACKGROUND

It is known to utilize various tabs, clips, etc. in place of “hard” fasteners such as bolts and/or screws, particularly when attaching vehicle elements such as headlamp assemblies, fog lamp assemblies, and the like to other vehicle elements such as grilles, fascia, etc. Conventional tabs are suited for their intended purpose, but suffer from a deficiency. For a conventional, substantially inflexible molded tab, the shear force imposed while inserting and attaching the vehicle element, particularly if the vehicle element is not properly centered/located, is great enough that the tab may break.

Accordingly, a need is identified in the art for improvements to tab fasteners for vehicle elements such as headlamp assemblies.

### SUMMARY

In accordance with the purposes and benefits described herein and to solve the above-summarized and other problems, in one aspect a fastener tab for connecting a first vehicle element to a second vehicle element is described, the fastener tab including a body comprising a head portion and a flexible neck portion. The head portion is configured to engage and capture a portion of the first vehicle element or the second vehicle element. The flexible neck portion includes a first length, a second length, and an intervening flexible length.

In embodiments, the intervening flexible length defines a living hinge. In certain embodiments, the fastener tab is associated with the vehicle element. In other embodiments, the fastener tab is associated with a portion of the vehicle grille assembly. The vehicle element may be any of a number of elements, including without intending any limitation a headlamp assembly, a fog lamp assembly, and a running light assembly.

In other aspects, vehicle grille assemblies including vehicle elements attached to a portion of a grille by the fastener tab as described above are provided.

In the following description, there are shown and described embodiments of the disclosed self-locating fastener tab. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed self-locating fastener tab, and together with the description serve to explain certain principles thereof. In the drawing:

FIG. 1 shows a vehicle including a first vehicle element attached to a second vehicle element;

FIG. 2 shows a prior art fastener tab;

FIG. 3 shows a self-locating fastener tab according to the present disclosure; and

FIG. 4 shows an alternative embodiment of the self-locating fastener tab of FIG. 3.

Reference will now be made in detail to embodiments of the disclosed self-locating fastener tab, examples of which are illustrated in the accompanying drawing figures wherein like reference numerals indicate like features.

### DETAILED DESCRIPTION

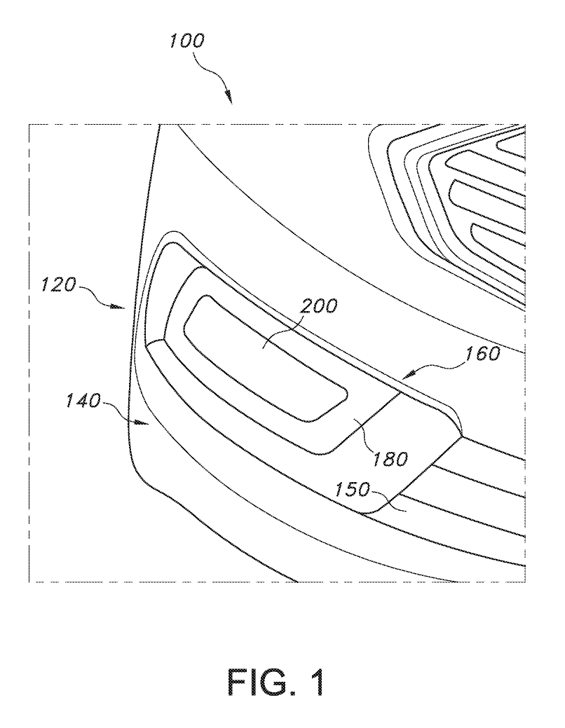

FIG. 1 illustrates a vehicle 100 including first vehicle element 120 attached to a second vehicle element 140. In the drawing figure, the second vehicle element 140 is a grille assembly 150 having a first vehicle element 120 attached thereto, in the depicted embodiment being a headlamp assembly 160 including a bezel 180 and a lamp 200. As summarized above, conventionally fastener tabs are used to provide a secure attachment between the headlamp assembly 160 and the grille assembly 150, for example to attach the bezel 180 to a portion of the grille assembly. As one example, molded grille tabs associated with the grille assembly 150 may be provided to attach the headlamp assembly 160 to the grille assembly. Alternatively, the molded tabs may be associated with a portion of the headlamp assembly 160.

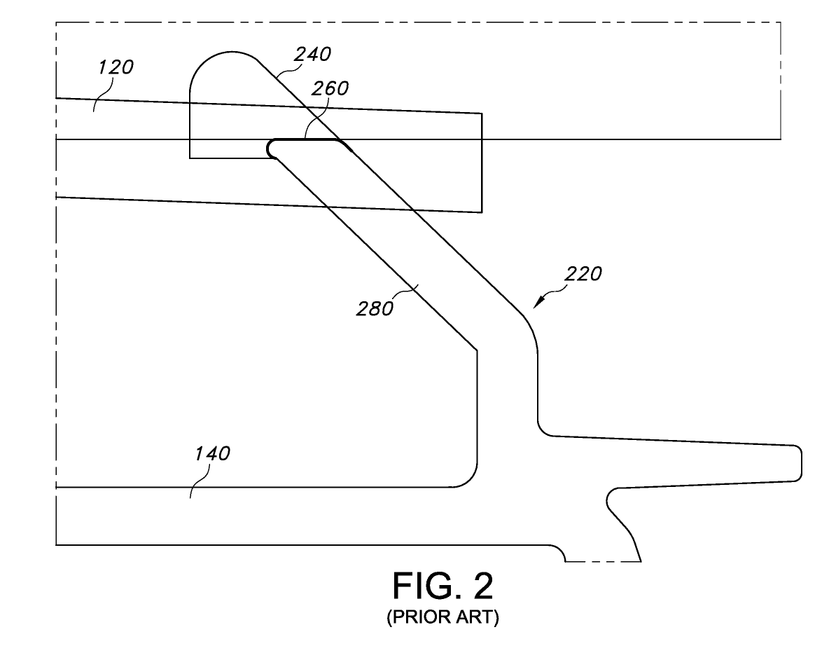

FIG. 2 depicts a prior art fastener tab 220 as is used in the industry, including a head portion 240 configured to engage and capture a cooperating aperture 260 disposed in a first vehicle element 120, and a neck portion 280. The neck portion 280 may be molded as part of a vehicle element 140, or may be provided with a base portion configured for attaching to the vehicle element (embodiment not shown).

Such fastener tabs 220 are placed to allow centering and locating, e.g., a headlamp assembly 160 to define a suitable margin and fit since usually there are no positive locators on either the headlamp assembly or the grille assembly 150. The fastener tabs 220 contact the headlamp assembly 160, biasing it into a properly centered position for attachment. Alternatively, if the fastener tabs 220 are associated with a portion of the headlamp assembly 160, they contact the grille assembly 150, again biasing the headlamp assembly into a properly centered position. Frontal biasing forces cause the fastener tabs 220 to engage the headlamp assembly 160. However, particularly if the headlamp assembly 160 is not properly centered before applying the frontal biasing forces, the shear force imposed on the fastener tabs 220 can cause them to break.

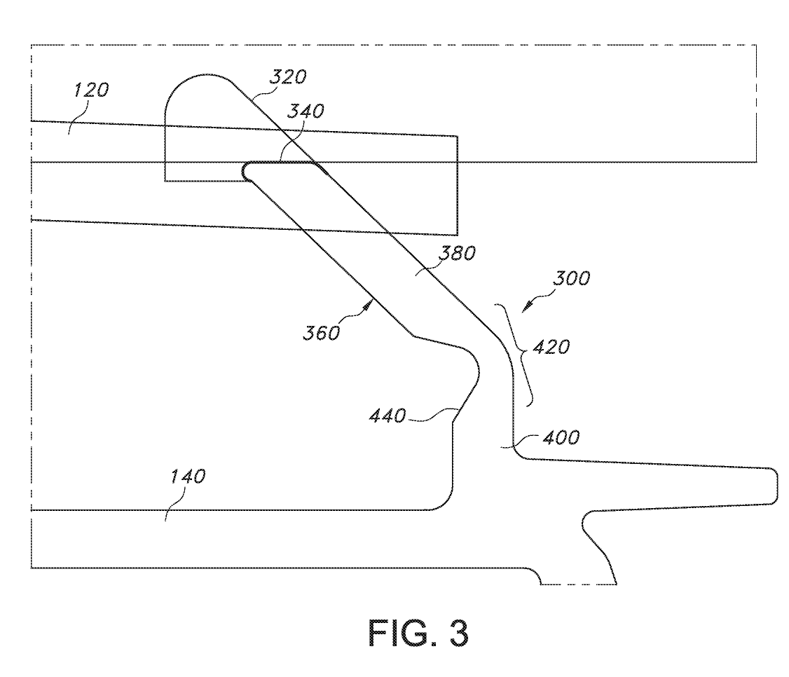

To solve this and other problems, with reference to FIG. 3 a self-locating fastener tab 300 is shown, including a head portion 320 configured to engage and capture a cooperating aperture 340 as described above, and a neck portion 360. As before, the neck portion 360 may be molded as part of a vehicle element, or may be provided with a base portion configured for attaching to a vehicle element (embodiment not shown).

The self-locating fastener tab 300 further includes a portion provided with enhanced flexibility, to provide an additional degree of flexibility and to allow the described self-locating functions. In particular, the self-locating fastener tab neck portion 360 includes a first neck length 380, a second neck length 400, and an intervening neck length 420 having a greater degree of flexibility compared to that of the first neck length and the second neck length.

In one embodiment (see FIG. 3), the intervening neck length 420 having a greater degree of flexibility is provided as a portion of the fastener tab neck portion 360 having a lesser thickness of material than the first neck length 380 and the second neck length 400, effectively creating a living hinge 440 at the intervening neck length 420. This can occur as part of the manufacturing process, for example by molding the self-locating fastener tab 300 to include the living hinge 440, or may be accomplished by removing a portion of the material of the fastener tab neck portion after the molding process is completed.

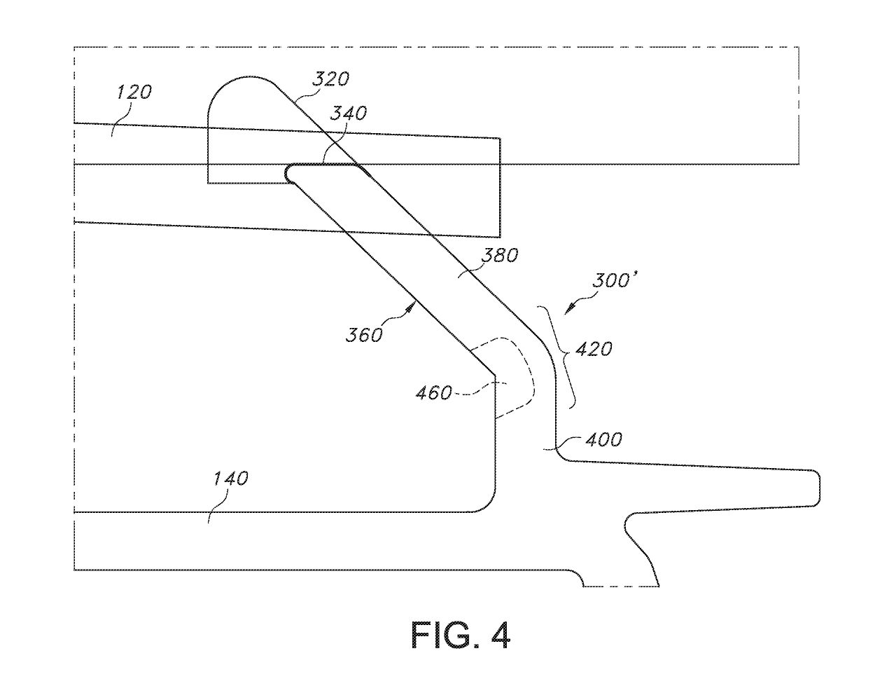

In alternative embodiments (see FIG. 4), a self-locating fastener tab 300′ may include an intervening neck length 420 provided by fabricating the intervening neck length to include a flexible section 460 made in whole or in part of a material having a greater degree of flexibility than that used to fabricate the first neck length 380 and the second neck length 400, thus increasing the flexibility of the neck portion 360 at the intervening neck length.

As will be appreciated, by the above-described self-locating fastener tabs 300, 300′ and the greater degree of flexibility provided by the intervening neck length 420 as described, advantageously a greater range of motion is provided for the fastener tab head portion 320 in locating a cooperating aperture 340. Thus, even if a first vehicle element 120 is held off-center when attaching to a second vehicle element 140, for example when attaching a headlamp assembly 160 to a motor vehicle grille assembly 150 manually or as part of an automated process, the increased flexibility of the self-locating fastener tabs 300, 300′ according to the present disclosure allows the headlamp assembly to be properly seated in and attached to the grill assembly, without risk of breakage of the fastener tab.

The foregoing has been presented for purposes of illustration and description. It is not intended to be exhaustive or to limit the embodiments to the precise form disclosed. Obvious modifications and variations are possible in light of the above teachings. For example, the foregoing description primarily describes attachment of various vehicle elements such as headlamp assemblies to vehicle grille assemblies. However, the skilled artisan will readily appreciate that the described self-locating fastener tab is applicable for attaching other vehicle elements such as fog lamps, running lights, and others. Likewise, the skilled artisan will readily appreciate that the described self-locating fastener tabs 300, 300′ are equally applicable for attaching such vehicle elements to other vehicle elements such as fascia.

Still more, it will be appreciated that the described self-locating fastener tabs 300, 300′ could be associated with either of the first vehicle element 120 or the second vehicle element 140, with the cooperating aperture 340 being associated with the other element. All such modifications and variations are within the scope of the appended claims when interpreted in accordance with the breadth to which they are fairly, legally and equitably entitled.

1. A fastener tab for connecting a first vehicle element to a second vehicle element, the fastener tab including a body comprising:
a head portion; and
a flexible neck portion including a first neck length, a second neck length, and an intervening flexible length having a greater degree of flexibility than either of the first neck length and the second neck length.

2. The fastener tab of claim 1, wherein the head portion is configured to engage and capture a portion of the first vehicle element or the second vehicle element.

3-4. (canceled)

5. The fastener tab of claim 1, wherein the fastener tab is associated with the first vehicle element.

6. The fastener tab of claim 1, wherein the fastener tab is associated with the second vehicle element.

7. The fastener tab of claim 1, wherein the intervening flexible length defines a living hinge.

8. The fastener tab of claim 1, wherein the first vehicle element is one of a headlamp assembly, a fog lamp assembly, and a running light assembly.

9. The fastener tab of claim 1, wherein the second vehicle element is one of a grille assembly and a fascia assembly.

10. A vehicle including the fastener tab of claim 1.

11. A vehicle grille assembly, comprising:
a grille; and
a vehicle element;
the vehicle element being attached to a portion of the grille by a fastener tab including a body comprising a head portion and a flexible neck portion defined by a first neck length, a second neck length, and an intervening flexible length having a greater degree of flexibility than either of the first neck length and the second neck length.

12. The vehicle grille assembly of claim 11, wherein the head portion is configured to engage and capture a portion of the vehicle grille assembly.

13. (canceled)

14. The vehicle grille assembly of claim 11, wherein the intervening flexible length defines a living hinge.

15. The vehicle grille assembly of claim 11, wherein the fastener tab is associated with the vehicle element.

16. The vehicle grille assembly of claim 11, wherein the fastener tab is associated with a portion of the vehicle grille assembly.

17. The vehicle grille assembly of claim 11, wherein the fastener tab is fabricated by a molding process.

18. The vehicle grille assembly of claim 11, wherein the vehicle element is one of a headlamp assembly, a fog lamp assembly, and a running light assembly.

19. A vehicle including the vehicle grille assembly of claim 11.

20. A self-locating fastener tab for connecting a first vehicle element to a second vehicle element, the self-locating fastener tab comprising a head portion and a neck portion comprising a first neck length and a second neck length separated by a living hinge having a greater degree of flexibility than either of the first neck length and the second neck length.
